(19) United States
(12) Patent Application Publication
(10) Pub. No.: US 2006/0289110 A1
(43) Pub. Date: Dec. 28, 2006

(54) Process for Manufacturing a Heating Sheet

(75) Inventors: Anne Schmitt, Mussig (FR); Guy Boiron, Wintzenheim (FR)

Correspondence Address: BANNER & WITCOFF, LTD., TEN SOUTH WACKER DRIVE, SUITE 3000, CHICAGO, IL, 60606, US

(73) Assignee: Societe Alsacienne D'Aluminum SA, Selestat Cedes (FR)

(21) Appl. No.: 11/380,155

(22) Filed: Apr. 25, 2006

(30) Foreign Application Priority Data
Apr. 25, 2005 (FR) 0504116

(51) Int. Cl. B32B 37/00; B32B 38/04; B29C 65/00

(52) U.S. Cl. 156/250

(57) ABSTRACT

A process for manufacturing a flexible heating sheet comprising two outer layers made of plastic material and a metal foil ribbon, arranged sinuously between the outer layers and acting as an electrical heating conductor using the Joule effect, includes a) printing a first face of a metal foil strip with a sinuous ribbon pattern and a second face with a pattern in an anti-bond lacquer complementary to the sinuous ribbon pattern, b) masking the first face of the metal strip by extrusion with a metal support film using a first extruded layer made of plastic, c) slicing the metal strip masked with the support film from the second face as far as the first extruded layer along the delimitation lines of the sinuous ribbon pattern and the complementary pattern, d) covering the second face of the metal foil strip with a second extruded layer made of plastic, e) covering the second face of the foil strip coated by extrusion using a first layer of glue with a first outer layer with a plastic film, f) separating the support film from part of the metal foil strip corresponding to the complementary pattern and bonding to the first extrusion layer, and g) covering the face of part of the metal strip forming the sinuous ribbon, released after separation from the support film, using a second layer of glue with a second outer layer made of plastic.

### CROSS-REFERENCE TO RELATED APPLICATION

This application claims priority to French Application No. 0504116 filed Apr. 25, 2005, which is incorporated herein by reference.

### BACKGROUND OF THE INVENTION

1. Field of the Invention

The invention relates to a process for manufacturing a flexible heating sheet comprising two outer plastic layers and a metal foil ribbon arranged sinuously between the outer layers and acting as an electrical heating conductor.

2. Background Art

Flexible heating sheets with an aluminum foil ribbon arranged sinuously between two PVC films and acting as an electrical heating conductor are used in heating applications, for example for floors and ceilings. Heating sheets connected to a power source at a safety voltage, for example equal to 48V, operate at a heating power with an order of magnitude of 100 W/m² surface area of the sheet.

Nowadays, these heating sheets are manufactured by manual gluing of aluminum foil ribbons sinuously on a PVC sheet and they are covered by gluing another PVC sheet. The sinuous trace is produced by folding the foil ribbon each time at an angle of 45° from the longitudinal axis of the sheet. Manual manufacturing of heating sheets requires a great deal of time, and cost effective industrial manufacturing of large numbers of parts is only feasible if there is a very large number of persons.

The problem that the invention is intended to solve consists of procuring a mechanized and economic process for manufacturing of flexible heating sheets with two outer plastic layers and a metal foil ribbon arranged sinuously between the outer layers and acting as an electrical heating conductor.

### BRIEF SUMMARY OF THE INVENTION

According to the invention, a process for manufacturing of a flexible heating sheet comprising a first outer layer and a second outer layer made of plastic material and an electrically conducting ribbon arranged along a sinuous pattern between the said outer layers and acting as an electrical heating conductor using the Joule effect, includes the following steps:

a) a first marked deposit of an anti-bond lacquer is formed on part of a first face of a strip made of an electrically conducting material, typically by a first impression, by forming a sinuous anti-bond ribbon according to the said pattern, the complementary part of the said part forming a pattern complementary to the said pattern not comprising an anti-bond lacquer, and a second marked deposit of the said anti-bond lacquer according to the said complementary pattern is formed on part of the second face of the said strip facing the said complementary pattern, typically by a second impression,

b) a layer of plastic material or a film made of plastic material called a support is applied or formed on the first face of the said strip, so as to mask the said first face, the said layer or the said support film being capable of bonding to the said complementary part of the said first face that does not comprise any anti-bond lacquer,

c) the said strip is sliced in its thickness from its second face, along a delimitation line separating the said pattern from the said complementary pattern, so as to form the said ribbon by cutting,

d) the said first outer layer and typically a first film made of plastic material is applied or formed on the second face of the said strip, the said first outer layer being capable of bonding to part of the said second face on which there is no anti-bond lacquer,

e) the support film and part of the said strip facing the said second marked deposit are separated, so as to obtain an intermediate sheet comprising part of the said strip forming the said ribbon fixed to the said first outer layer,

f) the said ribbon of the said intermediate sheet of the said second outer layer is covered, typically with a second film made of plastic material.

This manufacturing process solves the problems that arise.

As will become clearer later, particularly with reference to the figures, all steps a) to f) may typically be performed automatically with no direct manual action, so that it is thus possible to obtain a flexible heating sheet using a mechanized and economic process. A process according to the invention is very suitable for rational industrial manufacturing, and at least for steps a) to e), and typically steps a) to f), can be executed one after the other continuously.

### BRIEF DESCRIPTION OF THE FIGURES

FIG. 1 is a perspective view of a flexible heating sheet (10), with one corner of a second outer layer lifted so as to make one end of a ribbon accessible so as to fix it to an electrical cable (20) through a contact point, the remainder of the ribbon being represented by a dotted line.

FIG. 2 is a top view of a so-called first face of an intermediate metallic strip (22′) obtained in step a) of a process starting from a strip of plane metal. The first face of the metal strip is printed with an anti-bond lacquer (222) according to a pattern to form a first marked deposit (24), the complementary pattern without any anti-bond lacquer (222) being represented by a cross-hatched surface, patterns and being separated by a sinuous delimitation line (170).

FIG. 3 shows a section of the sheet strip in FIG. 2 along line I-I in the strip through a vertical plane perpendicular to the strip of plane metal.

FIGS. 4 to 10, similar to FIG. 3, illustrate the subsequent transformation of the metal strip in FIG. 3 and different steps in the process in order to obtain a heating sheet (10).

FIG. 4 illustrates step b) in the process with application of a support film on the first face of the intermediate metallic strip (22′) due to an extruded layer, so as to form a metalloplastic complex (48).

In this Figure, a cutting device (32) of the metal strip is shown facing the second face of the metal strip.

FIG. 5 illustrates step c) after the metal strip has been cut out: the metal strip cut by the cutting device through its entire thickness t includes a sinuous incision (34) along the delimitation line and forms an incised metalloplastic complex (48′).

FIGS. 6 and 7 illustrate an embodiment of step d) of the process with a second layer according to FIG. 6, extruded on the second face, and then according to FIG. 7, application of a film or extruded layer (40) to form a first outer layer (12).

FIG. 8 illustrates step e) of the process in which the support film is separated entraining a part of the metal strip corresponding to the complementary pattern in FIG. 2 with it.

FIG. 9 illustrates an intermediate sheet obtained after separation of the support film in step e) of a process according to the invention.

FIG. 10 illustrates step f) of the process in which a remaining part of the metallic strip forming the ribbon is covered with a film or an extruded layer (48) forming a second outer layer (14), particularly due to a second layer of glue.

FIGS. 11a to 11g illustrate another embodiment of the process according to the invention in which the support film is used through its first face (28a) and its second face (28b) so as to solidarise part of a metal strip to be removed in order to form the ribbon (16).

FIGS. 11a and 11b, corresponding to FIG. 3, are sections through intermediate metallic strips and obtained at the end of step a′) of a process.

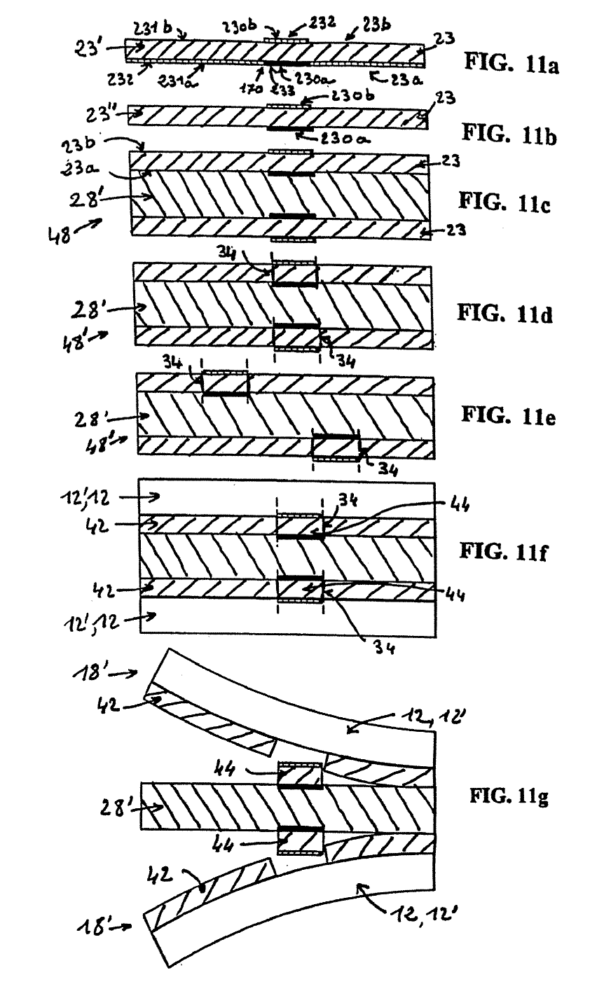

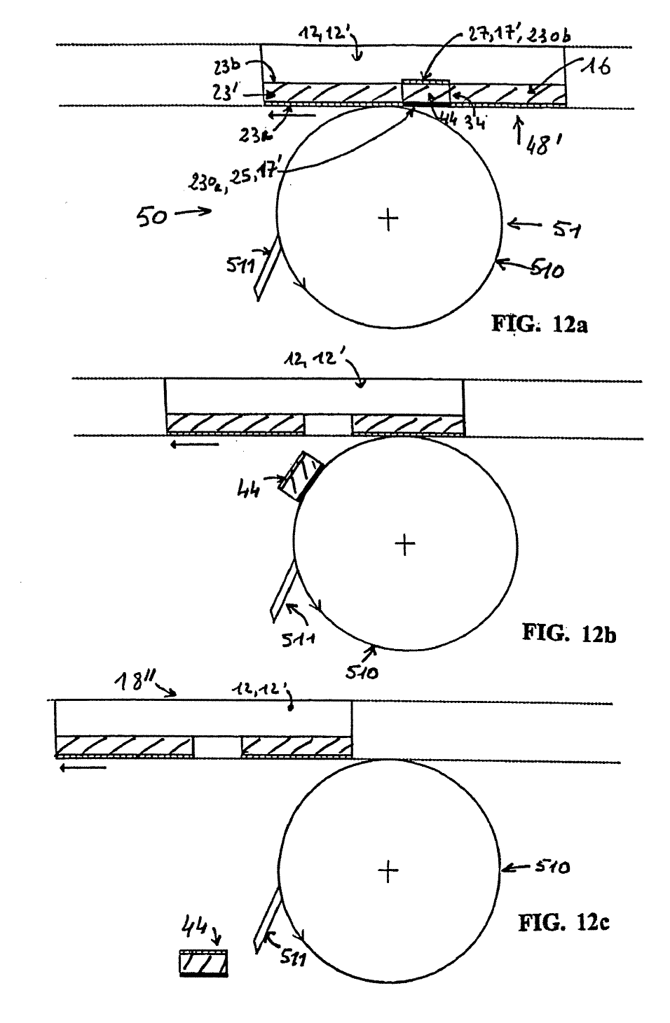

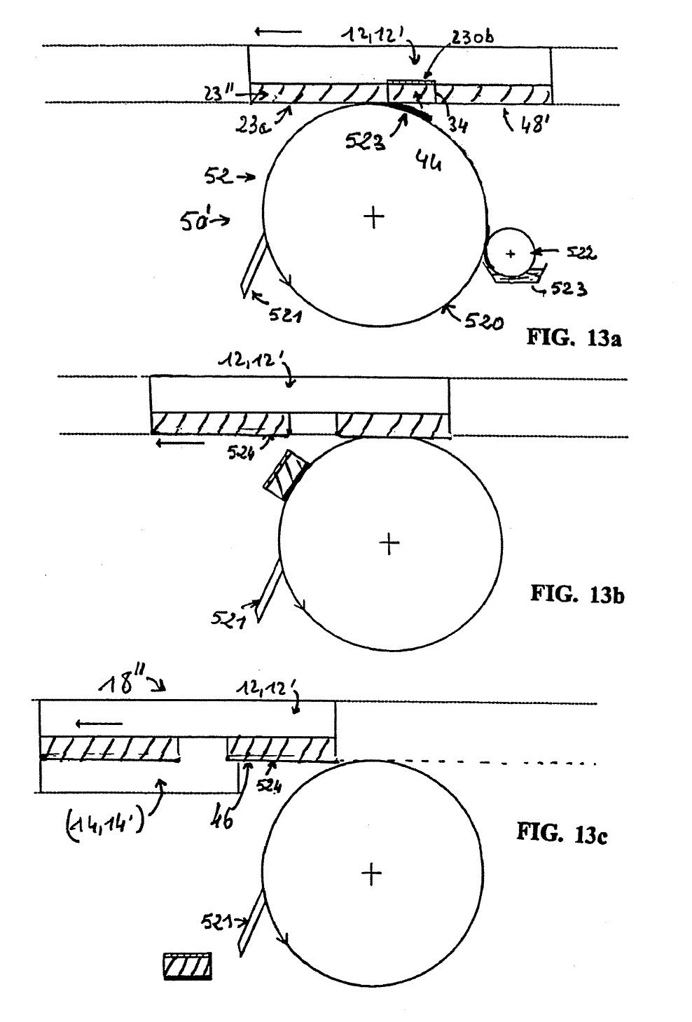

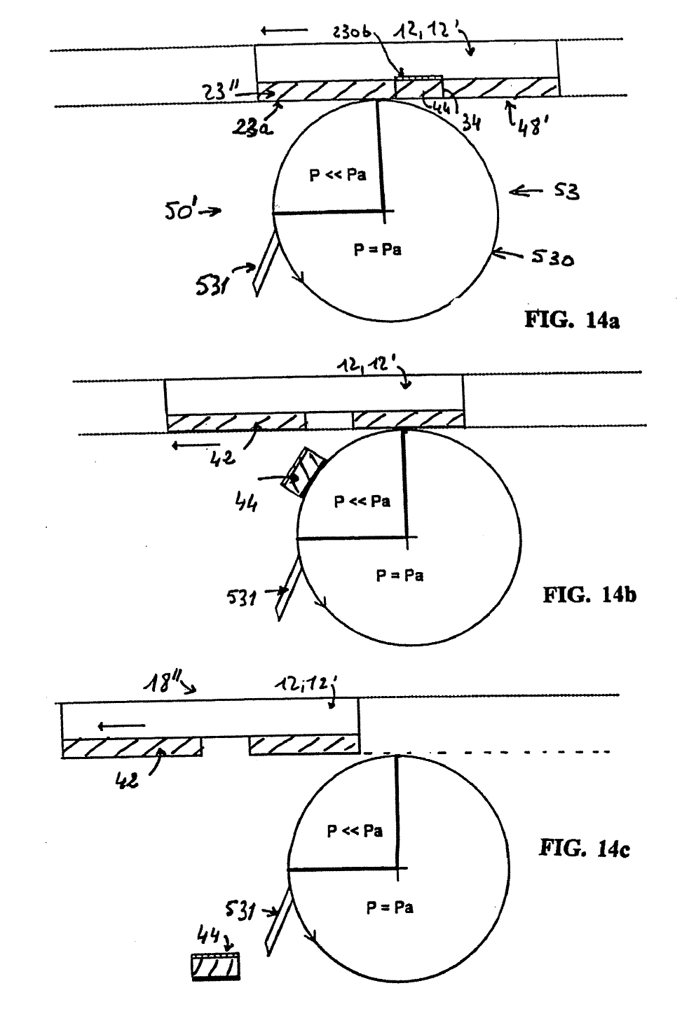

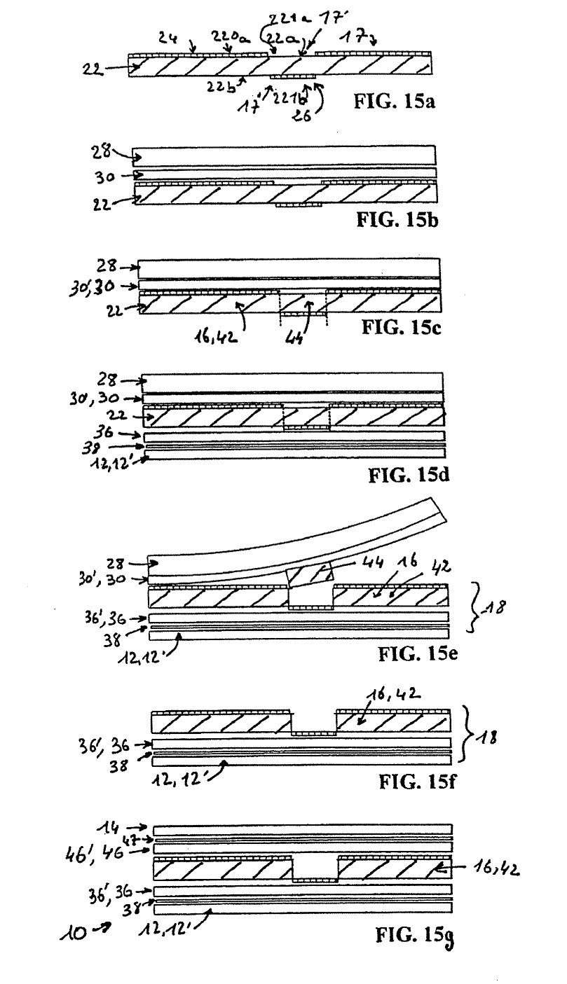

The intermediate metallic strip in FIG. 11a comprises a part comprising an adhesive (233), and a part comprising an anti-bond lacquer (232) on its first face (23a), the part presenting a pattern and the part presenting a complementary pattern, with a delimitation line between these two patterns. The intermediate metallic strip comprises a part on its second face comprising an anti-bond lacquer (232), facing the part (230a).

The intermediate metallic strip in FIG. 11b is distinguished from the intermediate metallic strip in FIG. 11a, in that the part of its first face does not have any anti-bond lacquer (232).

FIG. 11c corresponding to FIG. 4 illustrates step b′) of the process with application of the intermediate metallic strip on each face of the support film (28′), so as to form a metalloplastic complex (48) in which parts are facing each other.

FIG. 11d corresponding to FIG. 5, illustrates step c′) in the process by which the two intermediate metallic strips are sliced within their thickness to form sinuous incisions (34), and so as to form an incised metalloplastic complex (48′).

FIG. 11e is a variant of FIG. 11d in which the two intermediate metallic strips are offset from each other.

FIG. 11f illustrates step d′) of the process by which a first outer layer is applied or formed on a second face or the outer face of each of the two intermediate metallic strips, the first outer layer typically forming a first film made of plastic material.

FIG. 11g, corresponding to FIG. 8, diagrammatically shows the separation of the support film from the two intermediate sheets (18′).

FIGS. 12a to 12c are diagrammatic vertical sectional views in a vertical plane perpendicular to the metal strip illustrating a first embodiment of an automatic separation means according to the invention.

FIG. 12a shows a portion of an incised metalloplastic complex (48′) for which a first face comprises an adhesive part in contact with a mobile support forming a rotating cylinder (510) before part of the metal strip is entrained by the cylinder (510) and separated.

FIG. 12b shows part entrained by the cylinder (510) due to its adhesive layer (230a).

FIG. 12c shows the part separated from the cylinder (510) by the scraper (511), and the intermediate sheet obtained.

FIGS. 13a to 13c corresponding to FIGS. 12a to 12c, respectively, illustrate a second embodiment of the automatic separation means (50).

FIG. 13a shows a portion of an incised metalloplastic complex (48′) in contact with a mobile support forming a cylinder of a helioengraving printing device supplied with adhesive through a glue application cylinder (521) and capable of applying an unmarked adhesive layer (524) on a first face of the intermediate metallic strip using a scraper, before part is entrained by the cylinder.

FIG. 13b shows the part entrained by the cylinder (510) using the deposited adhesive layer.

FIG. 13c shows the part separated from the cylinder (510) by the scraper (511), and the intermediate sheet obtained. The second outer layer or the second film fixed to the intermediate sheets by the adhesive layer (524) is shown in dashed lines.

FIGS. 14a to 14c corresponding to FIGS. 12a to 12c, respectively, illustrate another embodiment of automatic separation means (50).

FIG. 14a shows a portion of an incised metalloplastic complex (48′) similar to that in FIG. 13a before the part is entrained, in contact with a mobile support forming a cylinder with a perforated cylinder wall, so that a vacuum can be created in it, so that the first face of the intermediate metallic strip can be brought into contact with the wall, and thus the part can be separated, possibly using a scraper (531).

FIG. 14b shows the part entrained by the cylinder due to the vacuum present in a quarter of the wall of the cylinder.

FIG. 14c shows the part separated from the cylinder by the scraper (531) and the intermediate sheet obtained.

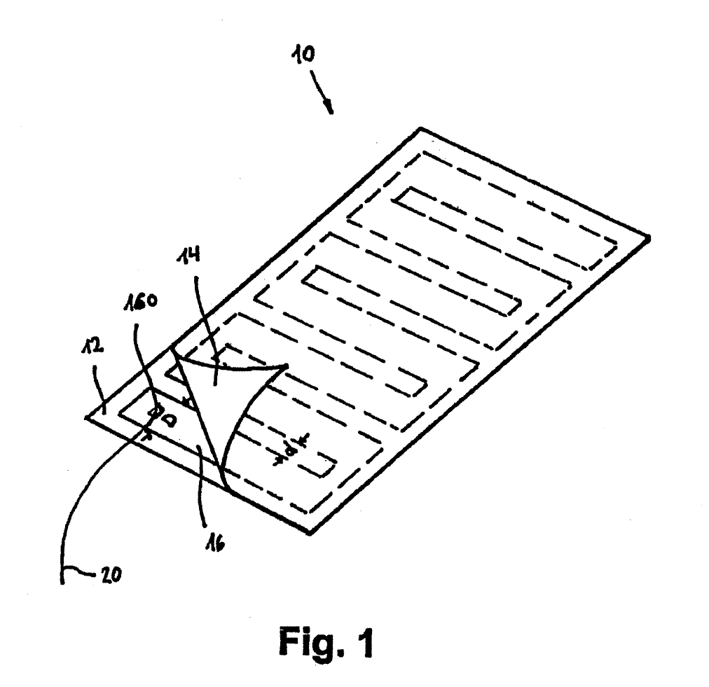

FIGS. 15a to 15g relate to an embodiment of the process similar to that shown in FIGS. 1 to 10.

FIG. 15a corresponding to FIG. 3 shows a strip of conducting material.

FIG. 15b corresponding to FIG. 4 before a cutting tool (32) is brought closer, represents the strip fixed to a support film by means of a first assembly layer.

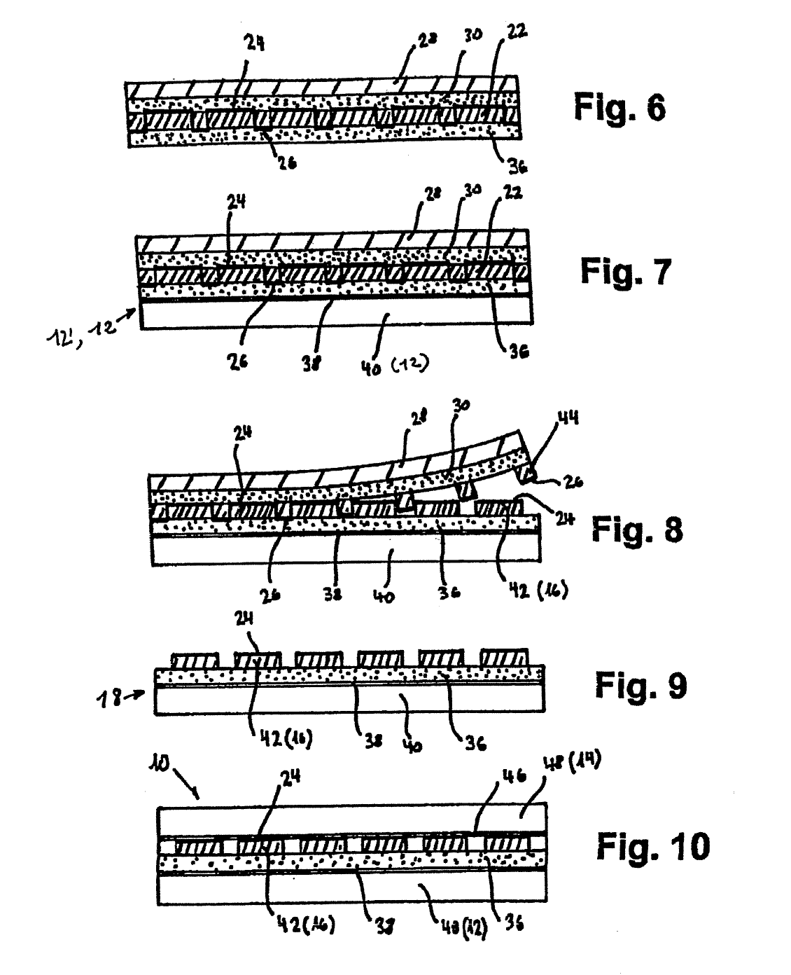

FIG. 15c, similar to FIG. 6, shows the multilayer material in FIG. 15b after the strip has been cut-out so as to form a ribbon (16).

FIG. 15d corresponding to FIG. 7, shows the multilayer material in FIG. 15c after a first outer layer has been assembled, due to a so-called second assembly layer (36, 36′) and a primer coat.

FIG. 15e corresponds to FIG. 8.

FIG. 15f corresponds to FIG. 9.

FIG. 15g corresponds to FIG. 10.

### DETAILED DESCRIPTION OF THE INVENTION

According to the invention, the strip of an electrically conducting material may be chosen to be a metal strip, typically made of aluminum or copper, a strip of electrically conducting polymers, a strip formed from or comprising a non-organic or inorganic electrically conducting material, typically a ceramic material.

More generally, any material or any metal with sufficient electrical conductivity can be used for a heating application by the Joule effect.

Advantageously, the strip can be a metallic strip that can be coated on both faces with a protective coat or a primer coat providing protection against corrosion or oxidation.

According to one variant of the invention and as shown in FIG. 4 or in FIG. 15b, a first assembly layer can be formed on the first face of the strip, during step b) of the process, so as to solidarise the support film to the first face of the strip.

The first assembly layer may be chosen from among a first extruded layer made of plastic material or a first coating layer of an adhesive material or glue.

In this case, in step c) of the process, the strip can be sliced in its thickness from the second face as far as the first assembly layer or the first extruded layer.

According to another variant of the invention and as shown in FIG. 7 or in FIG. 15d, a second assembly layer can be formed on the second face of the strip, during step d) of the process, so as to solidarise the first outer layer to the second face of the strip.

The second assembly layer may be chosen from among a second extruded layer made of plastic material (36′), typically a second extruded layer of PE, or a second coating layer of an adhesive material or glue.

However, possibly and as illustrated in FIG. 15d, the first outer layer may be fixed to the second assembly layer by means of a primer coat or a bond promoter.

In step e) of the process, and in the case in which a first assembly layer, typically a first extruded layer made of plastic material solidarises the support film to the first face, the support film may be separated from the part of the strip corresponding to the second pattern bonding to the first assembly layer, as illustrated in FIGS. 8 and 15e. The result is thus the intermediate layer shown in FIGS. 9 and 15f.

As illustrated in FIG. 10 or in FIG. 15g, in step f) of the process, the second outer layer may be fixed to the metal foil ribbon by means of a third assembly layer.

The third assembly layer may be chosen from among a third extruded layer made of plastic material typically a second extruded layer of PE, or a second coating layer made of an adhesive material or glue.

However, the second outer layer may be fixed to the third assembly layer by means of a primer coat or a bond promoter as illustrated in FIG. 15g.

Regardless of the variant of the invention, the support film may be a film made of a thermoplastic material chosen from among PET, PA, PP, PS. But other films either with similar mechanical characteristics, or used in thicker layers, could be suitable.

This film may be about 30 μm to 100 μm thick.

Typically, the first, second and third extruded layers may be extruded layers of PE, for example with a basis weight varying from about 20 to 50 g/m².

The first outer layer and the second outer layer may be composed of thermoplastic films (12′, 14′), for example made of PVC. For fire protection reasons, the outer layers are preferably composed of a PVC film that is difficult to inflame, with a thickness of about 100 μm to 300 μm and particularly about 150 μm to 250 μm.

However, when there is no need for fire protection, and particularly when the flexible heating sheet is embedded in a slab or in a wall, the said first outer layer and the second outer layer may be composed of thermoplastic films (12′, 14′) other than PVC.

The strip that will form the ribbon may be a metal strip with a thickness varying from 30 μm to 200 μm, typically from 50 μm to 120 μm and preferably from 70 μm to 90 μm.

These thicknesses firstly provide the means of ensuring sufficient electrical power for the heating strip and provide sufficient flexibility so that the heating sheet can form a coil.

The invention comprises a second embodiment of a process illustrated in FIGS. 11a to 11g in which the said steps a) to d) of the process may be replaced by the following steps:

a′) a first marked deposit of an adhesive according to a complementary pattern of the pattern is formed on a first face of a strip of an electrically conducting material typically by a first impression, and a second marked deposit of an anti-bond lacquer is formed on the second face facing the first marked deposit, typically by a second impression, according to the complementary pattern, so as to form an intermediate conducting strip in which the first face comprises an adhesive part comprising the adhesive and in which the second face comprises a non-bonding part comprising the anti-bond lacquer,

b′) the first face of the intermediate conducting strip is fixed to each face (28a, 28b) of a support film (28′), possibly using the first assembly layer, due to the adhesive part forming the marked deposit so as to form a three-layer strip, the support film thus being placed between two intermediate conducting strips (23′),

c′) the two intermediate conducting strips of the three-layer strip are sliced within their thickness along the delimitation lines between the pattern and the complementary pattern, so as to form the electrically conducting ribbon by cutting for each intermediate metallic strip, the outer face or the second face of each of the two intermediate conducting strips comprising the anti-bond lacquer forming the second deposit,

d′) the first outer layer is applied onto or formed on the second face or outer face of each of the two intermediate conducting strips, possibly using the second assembly layer, the first outer layer typically forming a first film made of plastic material, the first outer layer being capable of bonding to a part of the second face according to the pattern not including any anti-bond lacquer,

The next steps are steps e′) and f) in which:

e′) the support film is then separated carrying a part of the foil strip corresponding to the second pattern on each of its faces, so as to obtain two intermediate sheets (18′), each comprising the ribbon fixed to the first outer layer,

f) and finally, the ribbon is covered with the second outer layer (14), possibly using the third assembly layer.

In particular, this second embodiment provides the means of typically reducing by half the ratio of the weight of plastic material of the support per weight of metal to be recycled. Thus, the metal in part can be recycled with a reduced quantity of organic or plastic material, which is very advantageous for waste treatment.

In step a′, the first marked deposit of adhesive on the first face and the second deposit of anti-bond lacquer on the second face may be facing each other as illustrated in FIGS. 11a and 11b.

In step b′, the adhesive parts of the two intermediate metallic strips have adhesive parts that may face each other as illustrated in FIG. 11d, or they may be offset as illustrated in FIG. 11e.

Advantageously, and as illustrated in FIG. 11a, the first face may comprise a part according to the pattern comprising an anti-bond lacquer, the part forming a complementary part of the part comprising the adhesive.

In FIG. 11a, the adhesive layer is shown by a thick line, while the layer of anti-bond lacquer is shown by a vertically cross-hatched zone.

The invention comprises another manufacturing embodiment of a flexible heating sheet comprising a first outer layer and a second outer layer made of a metal foil ribbon arranged in a sinuous pattern between the outer layers (12, 14) and acting as an electrical heating conductor.

In this embodiment of the process illustrated in FIGS. 12a to 12c, the sequence of steps is as follows:

a) a first marked deposit of an adhesive according to a complementary pattern of the pattern is formed on a first face of a strip of an electrically conducting material typically by a first impression, and a second marked deposit of an anti-bond lacquer is formed on the second face facing the first marked deposit, typically by a second impression according to the complementary pattern, so as to form an intermediate conducting strip in which the first face comprises an adhesive part comprising the adhesive and in which the second face comprises a non-bonding part comprising the anti-bond lacquer

b) the first outer layer is applied or is formed on the second face of the intermediate conducting strip, possibly using an assembly layer, the first outer layer and typically a first film made of plastic material, the first outer layer being capable of bonding to a part of the second face not including any anti-bond lacquer,

c) the intermediate conducting strip is sliced in its thickness and from its first face along a delimitation line separating the pattern from the complementary pattern, so as to form the ribbon by cutting,

d) a part of the intermediate conducting strip forming the complementary pattern is cut using an automatic separation means (50), so as to obtain an intermediate sheet comprising a part of the intermediate conducting strip forming the ribbon fixed to the said first outer layer,

e) the ribbon is covered with the intermediate sheet of the second outer layer (14), and typically a second plastic film (14′), possibly using another assembly layer.

The automatic separation means in the previous step d) may include a mobile support (51), typically a rotating metallic cylinder (510) that can temporarily be in contact with the first face so as to entrain the part, and a scraper cooperating with the mobile support so as to separate the part from the mobile support (51), and thus to be able to compact and recycle the part (44).

In this embodiment of the process, the metal of the part can be recycled with a very small quantity of organic or plastic material, which is very advantageous.

The invention also comprises another method of producing a flexible heating sheet including a first outer layer and a second outer layer made of plastic material and an electrically conducting ribbon arranged in a sinuous pattern between the outer layers (12, 14) and acting as an electrical heating conductor.

The following sequence of steps is performed in this embodiment, as illustrated in FIGS. 13a to 14c:

a) a marked deposit of an anti-adhesion lacquer according to a complementary pattern of the pattern is formed on a face of a metal strip called the second face (23b), typically by printing, the marked deposit being called the second marked deposit (27), so as to form an intermediate conducting strip for which the second face comprises a non-bonding part comprising the anti-bond lacquer,

b) the first outer layer of the intermediate conducting strip is applied or is formed on the second face (23b), possibly using an assembly layer, followed by the first outer layer and typically a first film made of plastic material, first outer layer being capable of bonding to a part of the second face on which there is no anti-bond lacquer,

c) the intermediate conducting strip is sliced in its thickness and from its first face along a delimitation line separating the pattern from the complementary pattern so as to form the ribbon by cutting,

d) part of the intermediate conducting strip forming the complementary pattern is separated using an automatic separation means (50′), so as to obtain an intermediate sheet comprising a part of the metal strip forming the ribbon fixed to the first outer layer,

e) the ribbon is covered with the intermediate sheet, possibly using another assembly layer, the second outer layer (14), and typically a second film made of plastic material.

According to one variant illustrated in FIGS. 13a to 13c, the automatic separation means may include a mobile support, the mobile support forming or including a cylinder of a print device, typically a print cylinder supplied with an adhesive through a glue application cylinder so as to form a marked adhesive layer on the cylinder facing the non-bonding part (230b), and thus to entrain the part of the intermediate conducting strip forming the complementary pattern and to separate it from the cylinder by a scraper (521).

In this embodiment and according to a variant illustrated in FIGS. 14a to 14c, the automatic separation means may include a mobile support, the mobile support including or forming a cylinder with a perforated cylindrical wall, so that it can be put under a vacuum, so that the first face of the intermediate metallic strip can be forced into contact with the wall so that the part can be entrained by suction, and then separated from the wall, possibly using a scraper (531).

Regardless of the embodiments of the invention used and as illustrated in FIG. 1, the second outer layer may be chosen so as to be able to achieve partial manual delamination of the second outer layer in the flexible heating sheet (10), and thus be able to access a contact point of the ribbon (16).

### EXAMPLES

A heating sheet represented in FIG. 1 was manufactured. This heating sheet has an 80 μm thick aluminum foil ribbon arranged sinuously between two outer layers and made of a 200 μm thick PVC film, and acting as an electrical heating conductor. The width D of the foil ribbon is equal to 25 mm, and the distance d between adjacent ribbons in the sinuous pattern is equal to 15 mm. There is always a contact point at the two ends of the foil ribbon (16), that can be connected by an electrical cable to a power source, for example 48V. The average heating power of the heating sheet is of the order of 100 W/m².

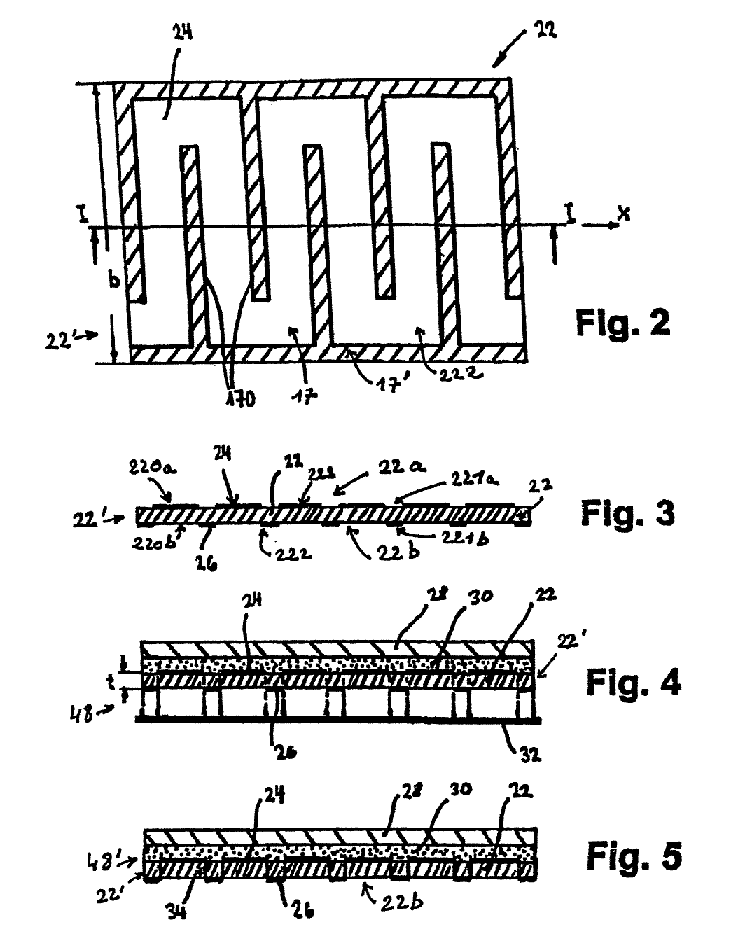

Manufacturing of this heating sheet is described in detail below with reference to FIGS. 2 to 10.

A metal strip made of aluminum foil with width b coated with a primer providing protection against corrosion and oxidation, is printed on a first face forming a first marked deposit (24) of an anti-bond lacquer according to a first sinuous pattern, and on the second face forming a second marked deposit of an anti-bond lacquer according to a complementary pattern of the pattern (17). In FIG. 2, the first marked deposit (24) according to the sinuous pattern can be recognized and is shown non-hatched, while the second marked deposit according to the complementary pattern is at the back on the other face and is shown cross-hatched in FIG. 2. The projection of the surfaces of the first deposit (24) according to the pattern and the second deposit according to the complementary pattern onto the plane of the drawing forms the complete surface of the metal strip, in other words the anti-bond lacquer surfaces of the two deposits (24) and according to the two patterns and have common delimitation lines in projection.

For continuous manufacturing of heating sheets (10), the metal strip is printed to deposit the anti-bond lacquer on its two faces and to form the deposit (24) according to the patterns and the second deposit according to the complementary pattern, using deposition cylinders arranged transverse to the circulation direction x of the metal strip.

The result is thus the intermediate metallic strip (22′) according to FIG. 3.

As illustrated in FIG. 4, a layer of PE with a basis weight of about 20 to 50 g/m² was extruded on the first face of the metallic strip (22′), so as to solidarise a 50 μm thick PET support film (28). The result is thus a metalloplastic complex (48).

As illustrated in FIGS. 4 and 5, the intermediate metallic strip (22′) of this metalloplastic complex (48) was then incised starting from its freely and directly accessible second face, according to a cut pattern corresponding to the delimitation lines of the two patterns and at the junction between the projections of the first deposit (24) and the second deposit of anti-adhesion lacquer. The incision was made with the cutting tool (32), for example placed on the surface of the cylindrical roll, the knives of this cutting tool (32) reproducing the shape of the delimitation lines (170). The incision is made with a sufficient cutting depth t to completely slice the intermediate metallic strip (22′) as far as the extruded layer made of PE, but without reaching the support film (28).

The result is thus a strip of an incised metalloplastic complex (48′), as shown in FIG. 5.

As illustrated in FIG. 6, the next step is to extrude a layer of PE with a basis weight of about 20 to 50 g/m², on the incised face of the intermediate metallic strip (22′).

As illustrated in FIG. 7, in a subsequent step, a glue layer (38) was deposited on the extruded layer of PE (36), so as to assemble an outer layer (40) with a PVC film corresponding to the outer layer in FIG. 1.

The extruded layer of PE firstly closes and seals the incisions in the metallic strip and secondly prevents unwanted migration of glue (38) on the surface of the metallic strip.

As illustrated in FIG. 8, the support film was separated entraining part of the metal strip with it so as to obtain the intermediate sheet in FIG. 9.

Firstly, the extruded layer of PE deposited on the first face of the intermediate metallic strip (22′) bonds on the surface of this strip (22′) in the part of this surface not coated with an anti-bond lacquer, this part forming the complementary part to the part coated with an anti-bond lacquer forming the first marked deposit (24), such that there is no adhesion between the extruded layer of PE and the sinuous ribbon pattern 24 of the anti-bond lacquer.

Secondly, the second extruded layer of PE also results in adhesion with uncoated areas not coated with anti-bond lacquer according to the complementary pattern of the second deposit (26), on the second incised face of the intermediate metallic strip (22′), while there is no adhesion between the extruded layer of PE and the second deposit corresponding to the part of the second face (22b).

Thus, the PET support film may be detached with a part of the metal strip corresponding to the complementary pattern of the second deposit and bonding to the extruded layer of PE.

After separation of the support sheet and the part of the metal strip that does not form part of the future heating conductor, a part of the metal strip forming the metallic ribbon corresponding to the sinuous shaped pattern remains, on the extruded layer of PE covered with the PVC film (40) forming the said first outer layer (12).

Thus, the result is an intermediate sheet as illustrated in FIG. 9.

In another step, the surface of the intermediate sheet with the sinuous part of the metal strip was covered with a PVC film by means of a glue layer forming the second outer layer (48) corresponding to the outer layer in FIG. 1, so as to obtain the terminated heating sheet shown in FIG. 10.

Given that the part of the metal strip was coated with an anti-adhesion lacquer according to the first marked deposit (24), the result is a lesser bond of the PVC film in the outer layer 48 onto the heating sheet (10), such that it can be removed with no great effort at the corresponding location, as shown in FIG. 1, to bring the foil ribbon 16 acting as a heating conductor into electrical contact. After contact has been made, the removed part of the PVC film (48) can once again be put into place.

A heating sheet is also manufactured as shown diagrammatically in FIGS. 15a to 15g.

Intermediate sheets (18′) were also manufactured, using the process shown in FIGS. 11a to 11g.

Intermediate sheets were also manufactured, using the processes shown in FIGS. 12a to 12c, 13a to 13c and 14a to 14c.

The invention discloses a plurality of processes capable of economically manufacturing flexible heating sheets (10), using traditional technical means used in manufacturing of flexible packagings.

We claim:

1. A process for manufacturing a flexible heating sheet comprising a first outer layer and a second outer layer made of plastic material and an electrically conducting ribbon arranged along a sinuous pattern between the outer layers and acting as an electrical heating conductor using the Joule effect, the process including the following steps:
a) forming a first marked deposit of an anti-bond lacquer on part of a first face of a strip made of an electrically conducting material, typically by a first impression, by forming a sinuous anti-bond ribbon according to the sinuous pattern, a complementary part of the part forming a pattern complementary to the sinuous pattern, the complementary pattern not comprising an anti-bond lacquer, and forming a second marked deposit of the anti-bond lacquer according to the complementary pattern on part of a second face of the strip, facing the said complementary pattern, typically by a second impression,
b) applying a layer of plastic material or a support film of plastic material on the first face of the strip, so as to mask the first face, the layer or the support film being capable of bonding to the complementary part of the first face that does not comprise any anti-bond lacquer,
c) slicing the strip through its thickness from its second face, along a delimitation line separating the pattern from the complementary pattern, so as to form the ribbon by cutting,
d) applying the first outer layer and a first film made of plastic material on the second face of the strip, the first outer layer capable of bonding to part of said second face on which there is no anti-bond lacquer,
e) separating the support film and part of the strip facing the second marked deposit to obtain an intermediate sheet comprising part of the strip forming the ribbon fixed to the first outer layer, and
f) covering the ribbon with the intermediate sheet of the second outer layer and a second film made of plastic material.

2. The process according to claim 1 in which the strip of an electrically conducting material is chosen to be a metal strip, a strip of electrically conducting polymers, or a strip of a non-organic or inorganic electrically conducting material.

3. The process according to claim 1 in which the strip is a metallic strip coated on both faces with a protective coat or a primer coat providing protection against corrosion or oxidation.

4. The process according to claim 1 in which a first assembly layer is formed on the first face of the strip, during step b), so as to solidarise the support film to the first face of the strip.

5. The process according to claim 4 in which the first assembly layer is chosen from among a first extruded layer made of plastic material or a first coating layer of an adhesive material.

6. The process according to claim 4 in which, in step c), the strip is sliced through its thickness from the second face as far as the first assembly layer or the first extruded layer.

7. The process according to claim 1 in which a second assembly layer is formed on the second face of the strip, during step d), so as to solidarise the first outer layer to the second face of the strip.

8. The process according to claim 7 in which the second assembly layer is chosen from among a second extruded layer made of plastic material or a second coating layer of an adhesive material.

9. The process according to claim 8 in which the first outer layer is fixed to the second assembly layer by means of a primer coat or a bond promoter.

10. The process according to claim 4 in which, in step e), the support film is separated from the part of the strip corresponding to the second pattern bonding to the first assembly layer.

11. The process according to claim 1 in which, in step f), the second outer layer is fixed to the ribbon by means of a third assembly layer.

12. The process according to claim 11 in which the third assembly layer is chosen from among a third extruded layer made of plastic material or a second coating layer made of an adhesive material.

13. The process according to claim 12 in which the second outer layer is fixed to the third assembly layer by means of a primer coat or a bond promoter.

14. The process according to claim 1 in which the support film is a film made of a thermoplastic material chosen from among PET, PA, PP, PS.

15. The process according to claims 5 in which the first, second and third extruded layers are extruded layers of PE.

16. The process according to claim 1 in which the first outer layer and the second outer layer are composed of thermoplastic films.

17. The process according to claim 1 in which the strip forming the ribbon is a metal strip with a thickness between from 30 μm to 200 μm.

18. The process according to claim 1 in which steps a) to e) are replaced by the following steps in which:
a′) forming a first marked deposit of an adhesive according to a complementary pattern of the pattern on a first face of a strip of an electrically conducting material typically by a first impression, and forming a second marked deposit of an anti-bond lacquer on a second face facing the first marked deposit, typically by a second impression, according to the complementary pattern, so as to form an intermediate conducting strip in which the first face comprises an adhesive part comprising an adhesive and in which the second face comprises a non-bonding part comprising the anti-bond lacquer,
b′) fixing the first face of the intermediate conducting strip to each face of a support film by the adhesive part forming the marked deposit so as to form a three-layer strip, the support film being placed between two intermediate conducting strips,
c′) slicing the two intermediate conducting strips of the three-layer strip within their thickness along the delimitation lines between the pattern and the complementary pattern to form the electrically conducting ribbon by cutting for each intermediate metallic strip, the outer face or the second face of each of the two intermediate conducting strips comprising the anti-bond lacquer forming the second deposit, and
d′) applying the first outer layer onto the second face of each of the two intermediate conducting strips to form a first film made of plastic material, the first outer layer being capable of bonding to a part of the second face according to the pattern not including any anti-bond lacquer.

19. The process according to claim 18 in which, in step a′, the first marked deposit of adhesive on the first face and the second deposit of anti-bond lacquer on the second face are facing each other.

20. The process according to claim 18 in which, in step b′, the two intermediate metallic strips have adhesive parts facing each other.

21. The process according to claim 18 in which the first face comprises a part according to the pattern comprising an anti-bond lacquer, the part forming a part complementary to the part comprising the adhesive.

22. A process for manufacturing a flexible heating sheet comprising a first outer layer and a second outer layer made of plastic material and an electrically conducting ribbon arranged in a sinuous pattern between the outer layers and acting as an electrical heating conductor, comprising the steps:
a) forming a first marked deposit of an adhesive according to a pattern complementary to the pattern on a first face of a strip of an electrically conducting material typically by a first impression, and forming a second marked deposit of an anti-bond lacquer on a second face facing the first marked deposit, typically by a second impression according to the said complementary pattern, to form an intermediate conducting strip in which the first face comprises an adhesive part comprising the adhesive and in which the second face comprises a non-bonding part comprising the anti-bond lacquer,
b) applying the first outer layer on the second face of the said intermediate conducting strip, the first outer layer and a first film made of plastic material, the first outer layer capable of bonding to a part of the second face not including any anti-bond lacquer,
c) slicing the intermediate conducting strip through its thickness and from the first face along a delimitation line separating the pattern from the complementary pattern, to form the ribbon by cutting,
d) cutting a part of the intermediate conducting strip forming the complementary pattern using an automatic separation means to obtain an intermediate sheet comprising a part of the intermediate conducting strip forming the ribbon fixed to the first outer layer, and
e) covering the ribbon with the intermediate sheet of the second outer layer and a second plastic film.

23. The process according to claim 22 in which, in step d), the automatic separation means includes a mobile support that can temporarily be in contact with the first face to entrain the part, and a scraper cooperating with the said mobile support to separate the part from the mobile support.

24. A process for manufacturing a flexible heating sheet including a first outer layer and a second outer layer made of plastic material and an electrically conducting ribbon arranged in a sinuous pattern between the outer layers and acting as an electrical heating conductor, comprising the steps of:
a) forming a marked deposit of an anti-adhesion lacquer according to a complementary pattern of the sinuous pattern on a second face of a metal strip to form an intermediate conducting strip for which the second face comprises a non-bonding part comprising the said anti-bond lacquer,
b) applying the first outer layer of the intermediate conducting strip on the second face, followed by the first outer layer and a first film made of plastic material, first outer layer capable of bonding to a part of the second face on which there is no anti-bond lacquer,
c) slicing the intermediate conducting strip through its thickness and from its first face along a delimitation line separating the pattern from the complementary pattern to form the ribbon by cutting,
d) separating part of the intermediate conducting strip forming the complementary pattern using an automatic separation means to obtain an intermediate sheet comprising a part of the metal strip forming the ribbon fixed to the first outer layer, and
e) covering the ribbon with the intermediate sheet, the second outer layer, and typically a second film made of plastic material.

25. The process according to claim 24 in which the automatic separation means includes a mobile support including a cylinder of a print device supplied with an adhesive through an application cylinder to form a marked adhesive layer on the cylinder facing the non-bonding part, and to entrain the part of the intermediate conducting strip forming the complementary pattern and to separate it from the cylinder by a scraper.

26. The process according to claim 24 in which the automatic separation means includes a mobile support including a cylinder with a perforated cylindrical wall, so that it can be put under a vacuum, the first face of the intermediate metallic strip being placed into contact with the wall to entrain the part by suction, and then separated from the wall.

27. The process according to claim 1 in which the second outer layer is selected to achieve partial manual delamination of the second outer layer in the flexible heating sheet to access a contact point of the ribbon.
